(19) United States
(12) Patent Application Publication
(10) Pub. No.: US 2011/0265670 A1
(43) Pub. Date: Nov. 3, 2011

(54) DEVICE FOR SQUEEZING FRUIT IN A BEVERAGE

(75) Inventor: Arvid Marinus Herman Bouman, Voorburg (NL)

(73) Assignee: CQ Holding B.V., BE The Hague (NL)

(21) Appl. No.: 13/122,626

(22) PCT Filed: Oct. 1, 2009
(86) PCT No.: PCT/EP2009/062769

§ 371 Date: May 25, 2011

(30) Foreign Application Priority Data
Oct. 6, 2008 (NL) 2002062

(51) Int. Cl. B30B 1/00

(52) U.S. Cl. 100/214

(57) ABSTRACT

Device for squeezing fruit (3) in a beverage, in particular citrus fruit, comprising an elongate member (10) and a squeezing surface (11) for squeezing said fruit, wherein the device furthermore comprises fruit holding means (12) arranged to hold the fruit. Preferably the fruit holding means are arranged to hold the fruit on the squeezing surface.

The invention relates to a device for squeezing fruit in a beverage, in particular citrus fruit, comprising an elongate member and a squeezing surface for squeezing said fruit.

Such a device is known.

It is common to serve a beverage such as a soda with for instance a slice of lemon. In order for the customer to be able to squeeze the juice out of the lemon, a device for squeezing said lemon is normally supplied. The device comprises an elongate member and a squeezing surface for squeezing said lemon. By squeezing the lemon between said surface and for instance the bottom of the glass containing the beverage, the juice can be squeezed out to the customer's taste. Such a device can also be used as a stirrer.

It is an objective of the invention to improve the known device and to provide a user friendly and/or easy to use device for squeezing fruit in a beverage.

In order to accomplish that objective, a device for squeezing fruit in a beverage of the kind referred to in the introduction is characterized in that the device furthermore comprises fruit holding means arranged to hold the fruit.

According to a first aspect of the invention, the device is provided with means for holding the fruit. This fruit holding means allow the fruit to be attached to the device such that the beverage can be served without the fruit being put in the beverage in advance. With the fruit being held by the device and not in the beverage, the customer can choose whether he wants to put the fruit in his drink. Preferably, the holding means are arranged to hold the fruit without contact between the fruit and the beverage when being served.

In a preferred embodiment of the device according to the invention the fruit holding means are arranged to hold the fruit on the squeezing surface. By holding the fruit on the squeezing surface, it is easier for the customer to squeeze the fruit. By moving the squeezing surface in contact with a surface from for instance the container, the fruit can be squeezed. More preferably, the holding means are arranged to hold the fruit, for instance a slice of lemon, in a plane substantially parallel to the squeezing surface. This results in an optimal contact between the squeezing surface and the fruit.

In a further preferred embodiment of the device the squeezing surface is located near an end of the elongate member preferably in a plane at least substantially perpendicular to the axis of the elongate member. The squeezing surface is located near an end of the device, making sure that the fruit is in contact with the beverage when being squeezed, even when the container is for instance half empty.

It is also possible to position the device according to the invention with the squeezing surface preferably holding the fruit facing upwards when being served. The other end of the elongate member hereby extends in the beverage. In this position, the fruit is not allowed to make contact with the beverage. By turning around the device, the fruit is put in the beverage and can be squeezed to the customer's taste.

Preferably the squeezing surface faces away from the other end of the elongate member. This allows easy squeezing of the fruit which is preferably held on the surface by pressing the device against the bottom of the container.

Where with the known device for squeezing fruit in a beverage the customer had to manoeuvre the fruit below the squeezing surface in order to squeeze said fruit, it is an advantage of the device according to the invention that the fruit is already held on said surface. By simply pressing the surface to the bottom of the glass, the juice can be squeezed out.

In a further preferred embodiment of the device according to the invention the fruit holding means are resilient. This allows easy attachment of the fruit to the device. Resilient holding means furthermore allow movement of the holding means with respect to the squeezing surface, allowing squeezing.

In a further preferred embodiment of the device the fruit holding means form an end of the device. It is easy for the customer to move an end of the device against for instance the bottom of the glass. For instance by deforming the holding means, the juice is squeezed out of the fruit.

In a further preferred embodiment of the device according to the invention the fruit holding means comprise an at least substantially hooked shaped member. The hooked shaped member allows a clamping action on the fruit, holding the latter.

Preferably, the size of the hook shaped member corresponds to the height and width of a piece of fruit to be held, for instance a slice of lemon.

In a further preferred embodiment of the device according to the invention the elongate member is connected to the squeezing surface at a location between the bending point of the resilient holding means and the location of connection of the holdings means to the device. This allows a substantially vertical movement of the elongate member when squeezing the fruit. Preferably the location of connection of the holding means and the bending point, or the point of inflection, of the holdings means are located on radial opposite sides of the squeezing surface. The resulting bending moment of the squeezing surface is hereby at least substantially zero. It should be noted that said locations are radial locations with respect to the elongate member, i.e. locations projected on the plane of the squeezing surface.

In a further preferred embodiment of the device according to the invention the fruit holding means comprise a wall moveable with respect to the squeezing surface, wherein the wall and the surface are arranged to hold the fruit there between. In this embodiment, the squeezing action is the result of two walls which are moveable to each other, whereby the fruit is held between said walls. Preferably, the holding means and the squeezing surface form a housing, holding the fruit. The housing allows a reliable holding action of the fruit.

Preferably at least one of the wall or the surface is connected to the elongate member for moving said wall or surface. By handling the elongate member, the customer can squeeze out the juice of the fruit held between the wall and the squeezing surface. Although the handling of the elongate member can comprise a compressive movement, it is also possible that the elongate member is rotated with respect to the wall or the squeezing surface, changing the relative orientation between the two which results in a squeezing action.

It can be advantageously to provide both the wall and the squeezing surface with an elongate member, allowing easy handling of an elongate member for moving the wall and/or the squeezing surface. Preferably, the two elongate members extend substantially rectilinear in the unused position.

In a further preferred embodiment of the device according to the invention at least one of the fruit holding means or the squeezing surface comprises a surface structure for enhancing the holding action of the fruit. The squeezing surface and/or the holding means in the form of for instance the hooked shaped member or the wall can be provided with a surface structure, for instance in the form of spikes or ribs, enhancing the holding action and/or the squeezing action.

According to a second aspect of the invention, the device comprises container holding means arranged to hold the device to a container, in particular a glass, containing the beverage. This allows the device to be placed for instance on the outside on the glass without the need for the device to extend in the beverage at serving. The device can then be taken of the glass by the customer and used to squeeze the fruit in the beverage. Preferably the container holding means are arranged to hold the device to the container without the device making contact with the beverage. If the device is not being used, it can simply be put away, without the need to dry the device. Furthermore, attaching the device for squeezing fruit to the glass enhances the presentation of the served product.

More preferably the container holding means comprise an at least substantially hooked shaped member arranged to engage the edge of the container. The hooked shaped member can be placed around the edge of the glass, resulting in a firm holding action.

It is advantageously when the container holding means, for instance in the form of a hooked shaped member, are resilient, allowing a firm clamping relation on the glass, preferably around the edge of the glass.

Preferably the container holding means are arranged to hold the device in an at least substantially vertical orientation. This allows a compact composition.

It is furthermore advantageously when the device according to the invention is provided with both fruit holding means and container holding means. This device allows the fruit to be held on the device while the device can be placed on the glass. This results in an attractive product while serving the beverage. Using the container holding means, it is not necessary to place one end of the elongate member in the beverage as is now customary, resulting in a clean device.

It is furthermore advantageously that the customer can decide whether he wants the fruit in his drink or not. If he decides so, he simple takes of the device from the container and places the fruit holding means in the beverage. On the other hand, the device containing the fruit can also be placed for instance next to the drink, without the need for the customer to ‘fish out’ the fruit from the beverage.

It should however be remarked that it is also possible to provide a device for squeezing fruit in a beverage comprising container holding means without fruit holding means.

The present invention is further illustrated by the following Figures, which show preferred embodiments of the device according to the invention, and are not intended to limit the scope of the invention in any way, wherein:

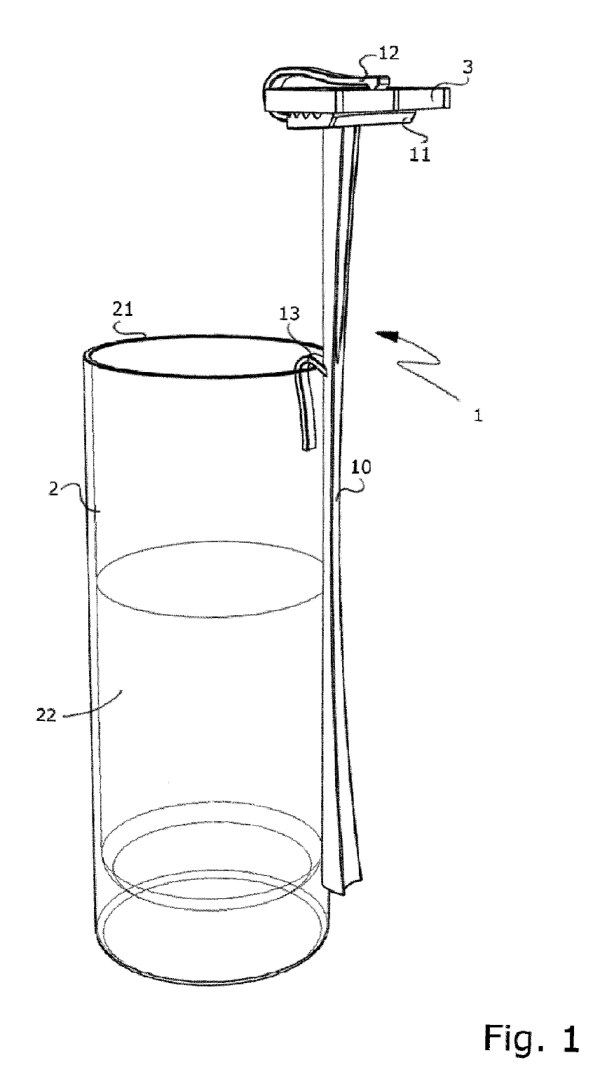

FIG. 1 schematically shows a device according to the invention attached to a glass;

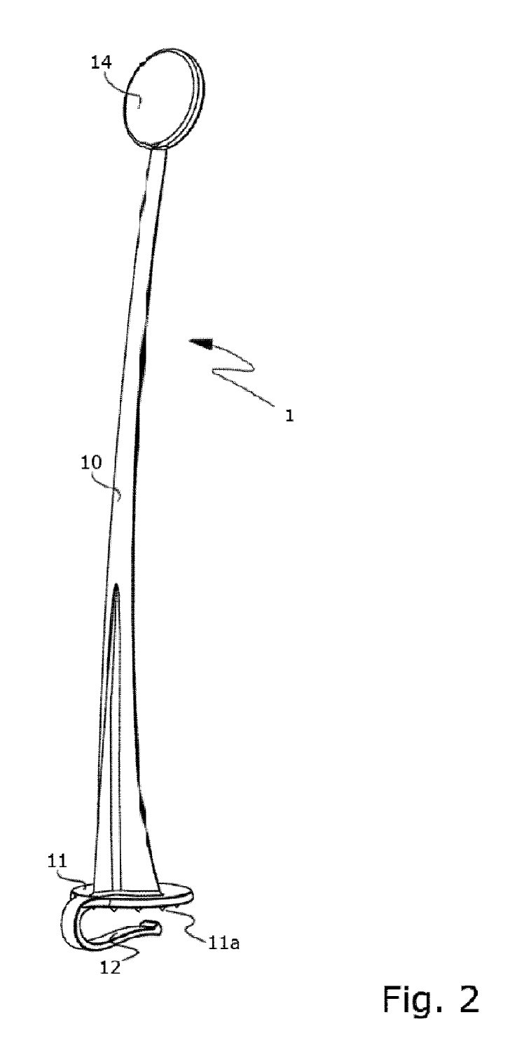

FIGS. 2-6 schematically show other embodiments of the device according to the invention, and;

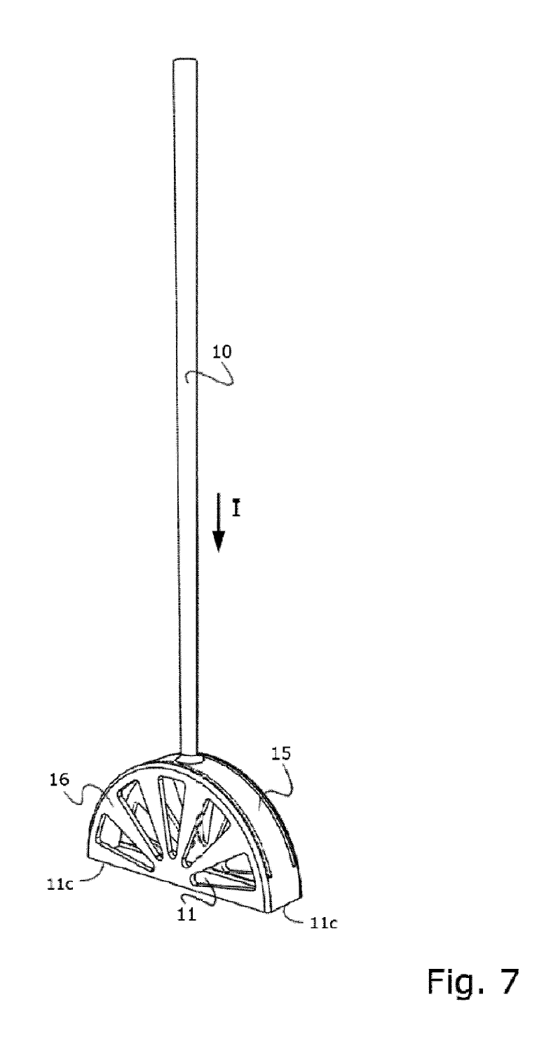

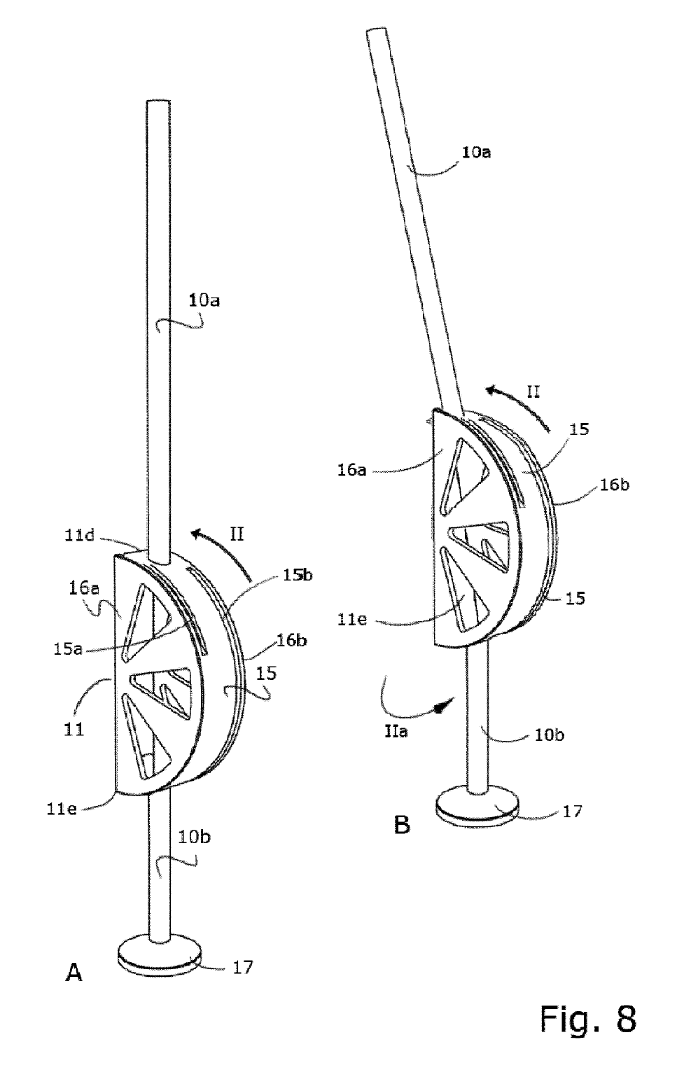

FIGS. 7 and 8a-b schematically show further embodiments of the device.

In FIG. 1, a device 1 according to the invention is shown. The device 1 comprises an elongate member 10 and a squeezing surface 11 for squeezing fruit 3. Such a device 1 is also suitable to use as a stirrer. The device 1 is furthermore provided with fruit holding means in the form of a hook 12. The hook 12 is arranged to hold the fruit, in this case a slice of lemon 3, on the squeezing surface 11. The slice 3 extends substantially parallel to the squeezing surface 11. In this embodiment the squeezing surface 11 has a half circular shape, corresponding to the slice 3 placed between the hook 12 and the surface 11.

The holding means in the form of the hook 12 form the end of the device 1. When the device is placed in the beverage 22 held in a glass 2 with the fruit holding portion facing down and pressed against the bottom of the glass 2, the hook 12 deforms since the hook 12 is resilient, resulting in a squeezing action. The resilient hook 12 also allows a good clamping action on the slice 3 between said hook 12 and the squeezing surface 11. Furthermore, since the fruit does not make contact with the beverage 22 in the situation as shown in FIG. 1, the customer has the choice of leaving out the fruit from the drink, without the need to take the fruit out of the drink.

The device 1 is furthermore provided with container holding means 2 in the form of a glass hook 13. The hook 13 is arranged to engage the edge 21 of the glass 2 and engages the inner surface of the glass, resulting in a good gripping action. The hook 13 is also manufactured from a resilient material, for instance plastic, which allows a clamping action of the hook 13 on the glass 2.

The open side of the hook 13 faces away from the squeezing surface 11 provided with the fruit hook 12, such that the fruit 3 held by the device 1 extends above the edge 21 of the glass 2 when being held by said glass 2.

In the situation as shown in FIG. 1, the device according to the invention does not make any contact with the beverage 22 contained in the glass 2. This makes it possible for the customer to simply take the device off from the glass 2 and put it away, without the danger of leaving stains from the beverage 22.

In FIG. 2 another embodiment of the device 1 is shown. In this embodiment, the device lacks the container hook 13. When serving the beverage with the device of FIG. 2, the end 14 of the elongate member 10 can be placed in the beverage 22, preventing contact between the fruit held by the fruit holding means 12 and the beverage 22. The end 14 can for instance be provided with a logo for a beverage brand. Also shown is that the squeezing surface 11 is provided with a surface structure in the form of spikes 11a to improve the squeezing action of the surface 11. In this embodiment, the surface 11 has a circular shape.

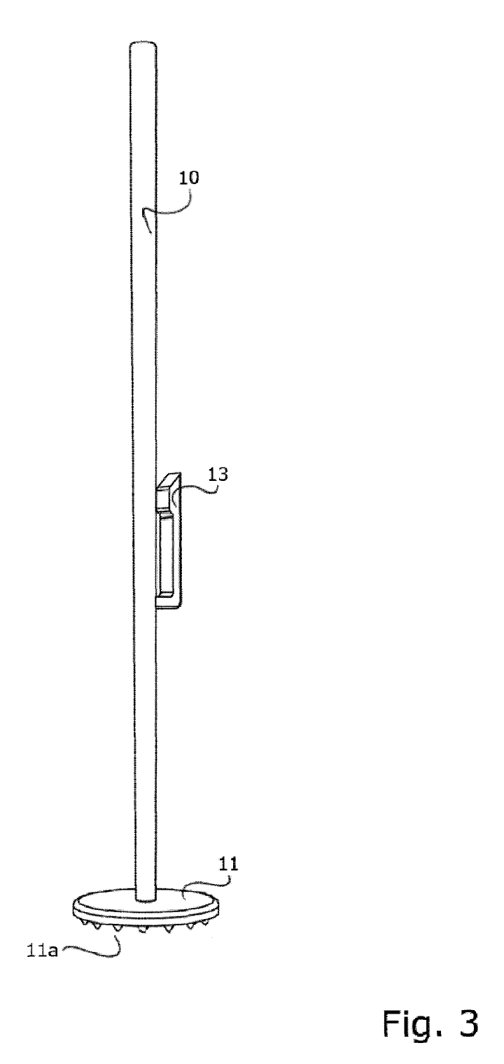

The device as shown in FIG. 3 comprises an elongate member 10 and a squeezing surface 11 provided on an end of said elongate member 10. The squeezing surface 11 is provided with pikes 11a to improve the squeezing action of the surface. The device is furthermore provided with container holding means in the form of a hook 13.

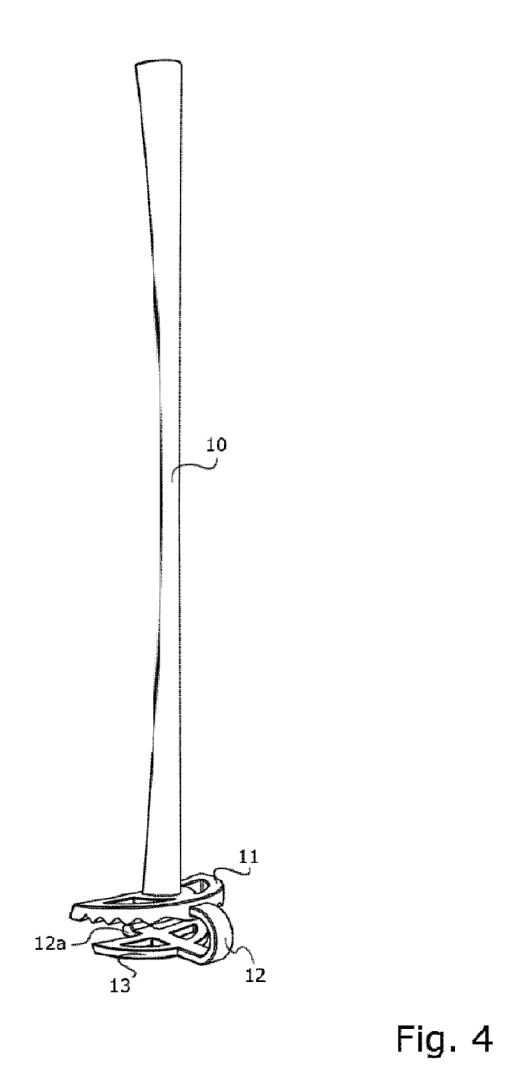

In FIG. 4 a variant is shown. In this variant, the holding means in form of a hook 12 is provided with extensions 13 forming a second surface. The extensions 13 and the hook 12 provide a strong holding action of the fruit between said hook 12 and extensions 13 and the squeezing surface 11. The hook 12 is furthermore provided with a rib 12a which is arranged to grip the edge of the fruit to be held. The fruit then extends between the hook 12 and the rib 12a. The squeezing surface 11 is also provided with a surface structure in the form of ribs.

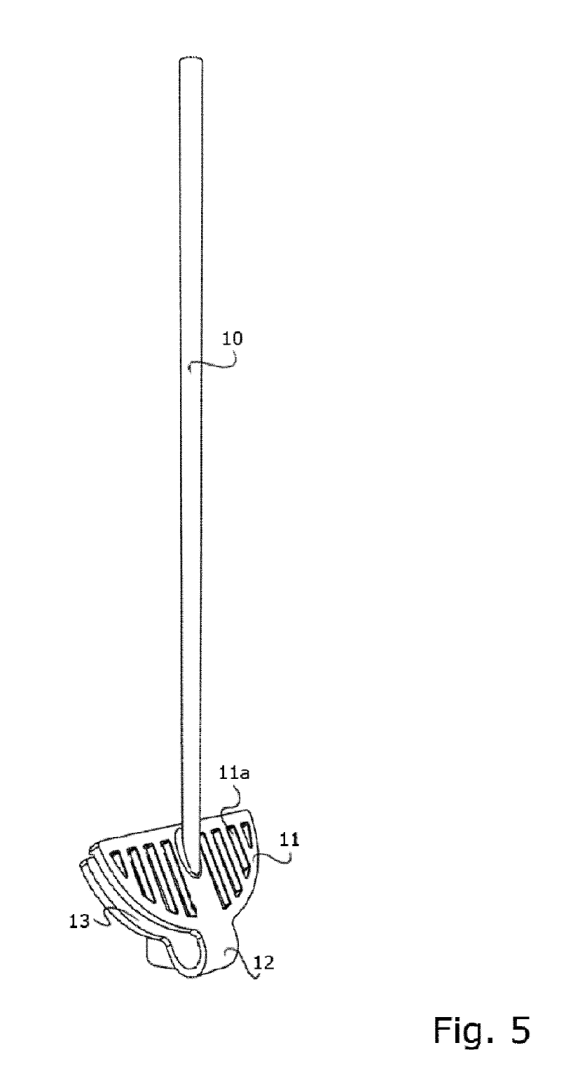

The hook shaped member 12 device of FIG. 5 is also provided with extensions to form a second surface for clamping the fruit. The surfaces 11 and 13 are provided with surface structures in the form of slots, indicated with 11a, allowing passing through of the squeezed out juice.

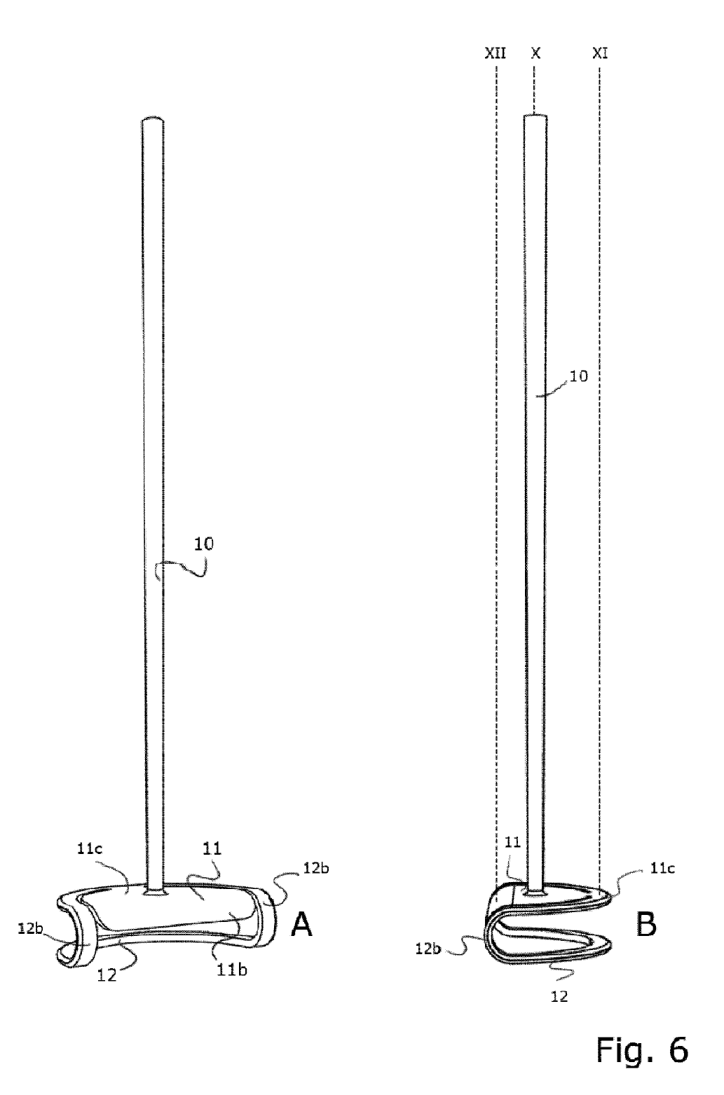

In FIGS. 6A and 6B, the squeezing surface 11 is provided with a protruding edge 11b which is arranged to receive an edge of the fruit allowing a firm holding action. The holding means are arranged in the form of a hooked shaped member 12 which extends in circle segment, substantially parallel to the squeezing surface 11. When squeezing the fruit held between the holding means and the squeezing surface 11, the bending of the holding means will at least substantially take place around the bending point or point of inflection indicated with 12b. The holdings means in the form of the hooked shaped member 12 are connected to the squeezing surface 11 at a location 11c.

As can more clearly be seen in the side view of FIG. 6B, the elongate member 10 is connected to the squeezing surface at a point, indicated with axis X, on a location between the location of the bending point 12b, indicated with axis XII, and the connection 11c of the holding means 12 to the device, in this case the squeezing surface 11, indicated with axis XI. It should be noted that the locations of connection and bending should be interpreted as radial location with respect to the axis of the elongate member 10. The connection location 11c and the bending point 12b extend at radially opposed locations on the squeezing surface 11. Such a composition allows a substantially vertical movement of the elongate member 10 along axis X when squeezing the fruit, without any substantial deflection of said member 10 in any other direction.

In FIG. 7 a next variant of the device according to the invention is shown. In this embodiment, the holding means comprise a wall 15 which is moveable with respect to the squeezing surface 11. The wall 15 has a curved surface in the form of the fruit to be held, in this case a half slice of lemon. The holding means furthermore comprise side walls 16 such that the holding means form a housing for holding the fruit. The wall 15 is resiliently connected to the lateral ends 11c of the squeezing surface 11 and the wall 15 is free to move with respect to side walls 16. The side walls 16 are to his end connected to the squeezing surface 11. The elongate member 10 is connected to the wall 15 and by pressing the elongate member 10 in a direction indicated with I, the wall 15 moves with respect to the squeezing surface 11, reducing the space there between resulting in squeezing. To be able to insert a slice of fruit in de device of FIG. 7, the front side wall 16 can for instance be removed.

A variant of the device of FIG. 7 is shown in FIG. 8A. In this embodiment the squeezing surface 11 extends in a plane parallel to the axis of the elongate member 10a. Opposing the squeezing surface 11 is the wall 15. The holding means furthermore comprise side walls 16a, b. At an upper end 11c of the squeezing surface 11, the surface 11 is connected to the wall 15. A first elongate member 10a is provided here. A lower end 11e of the surface is free to move with respect to the wall 15. The wall 15 near the lower end 11e is provided with a second elongate member 10b. A foot 17 is provided on member 10b. Furthermore, slots 15a, b are provided allowing movement between the side walls 16a, b and the wall 15.

By rotating elongate member 10a in a direction indicated with II, the end 11e of the squeezing surface 11 will move in a direction indicated with IIa in FIG. 8B. The wall 15 will remain substantially stationary due to the elongate member 10b provided with the foot 17. The relative movement of the squeezing surface 11 with respect to the wall 15 will result in squeezing action on the fruit held between said surface 11 and said wall 15.

By moving the elongate member 10a in a direction opposite to II, the squeezing surface 11 will move in a direction opposite to the direction indicated with IIa. In this position it is possible to insert fruit between the squeezing surface 11 and the wall 15.

The present invention is not limited to the embodiment shown, but extends also to other embodiments falling within the scope of the appended claims. It is for instance possible to provide the devices from FIGS. 2 and 4 to 8 with container holding means as shown for instance in FIGS. 1 and 3.

1. Device for squeezing fruit in a beverage, in particular citrus fruit, comprising an elongate member and a squeezing surface for squeezing said fruit, characterised in that the device furthermore comprises fruit holding means arranged to hold the fruit.

2. Device according to claim 1, wherein the fruit holding means are arranged to hold the fruit on the squeezing surface.

3. Device according to claim 1, wherein the squeezing surface is located near an end of the elongate member in a plane at least substantially perpendicular to the axis of the elongate member.

4. Device according to claim 3, wherein the squeezing surface faces away from the other end of the elongate member.

5. Device according to claim 1 4, wherein the fruit holding means are resilient.

6. Device according to claim 3, wherein the fruit holding means form an end of the device.

7. Device according to claim 1, wherein the fruit holding means comprise an at least substantially hooked shaped member.

8. Device according to claim 5, wherein the elongate member is connected to the squeezing surface at a location between the bending point of the resilient holding means and the location of connection of the holdings means to the device.

9. Device according to any of the preceding claims 1 to 8, wherein the fruit holding means comprise a wall moveable with respect to the squeezing surface, wherein the wall and the surface are arranged to hold the fruit there between.

10. Device according to claim 9, wherein at least one of the wall or the surface is connected to the elongate member for moving said wall or surface.

11. Device according to claim 1, wherein at least one of the fruit holding means or the squeezing surface comprises a surface structure for enhancing the holding action of the fruit.

12. Device according to claim 1, wherein the device comprises container holding means arranged to hold the device to a container, in particular a glass, containing the beverage.

13. Device according to claim 12, wherein the container holding means comprise an at least substantially hooked shaped member arranged to engage the edge of the container.

14. Device according to claim 12, wherein the container holding means are arranged to hold the device in an at least substantially vertical orientation.
